(19) United States
(12) Patent Application Publication
(10) Pub. No.: US 2008/0078034 A1
(43) Pub. Date: Apr. 3, 2008

(54) Method for dyeing high density polyethelene fiber fabric

(75) Inventors: Jonathan Kaufman, Leonardtown, MD (US); Rodney Pursell, Lexington Park, MD (US); Lynn B. Klett, Knoxville, TN (US); James W. Klett, Knoxville, TN (US)

Correspondence Address: NAVAL AIR WARFARE CENTER AIRCRAFT;DIVISION OFFICE OF COUNSEL BLDG 435, SUITE A, 47076 LILJENCRANTZ ROAD UNIT 7, PATUXENT RIVER, MD, 20670, US

(73) Assignee: Department of the Navy

(21) Appl. No.: 11/543,277

(22) Filed: Sep. 29, 2006

(51) Int. Cl. C11D 3/00

(52) U.S. Cl. 8/115.51

(57) ABSTRACT

A method for dyeing high density polyethelene fiber fabric, which includes applying an aliphatic stain on the fabric.

### STATEMENT OF GOVERNMENT INTEREST

The invention described herein may be manufactured and used by or for the Government of the United States of America for governmental purposes without payment of any royalties thereon or therefor.

### BACKGROUND

The present invention relates to a method for dyeing high density polyethelene fiber fabric. More specifically, but without limitation, the present invention relates to a method for permanently dyeing Spectra® or high density polyethelene fiber fabric.

Spectra® fabric is a high molecular weight polyethelene fiber fabric, generically known as high density polyethelene fiber fabric. High density polyethelene fiber fabric is highly durable which tests have shown to be just as strong as Kevlar, but much lighter. These properties of high density polyethelene fiber fabric lend themselves for military use, particularly for battle fatigues. However, high density polyethelene fiber fabric is highly resistant to dyes and colorization, and there is no technique previously known to permanently impart multi-colors onto high density polyethelene fiber fabric. Color can be introduced into the high density polyethelene fiber fabric precursor material before the fibers are spun. However, this only results in a single color filament. Previous methods to impart color onto high density polyethelene fiber fabric involve either blending of other threads, coating the threads with other materials or sewing another material onto the surface of the fabric.

A semi-permanent method was developed by BBS Technologies, which utilized a waxy substance to coat Spectra® fishing line and was applied to the Spectra® fabric. However, after several washings in a standard washing machine, the color faded and began to come off. None of these methods were appropriate for certain military applications.

Thus, there is a need in the art to provide a method to dye Spectra® or high density polyethelene fiber fabric without the limitations inherent in present methods.

### SUMMARY

The method for dyeing high density polyethelene fiber fabric includes applying an aliphatic stain on the fabric.

It is a feature of the invention to provide a method to dye high density polyethelene fiber fabric wherein the dye is substantially permanent and withstands repeated washing and drying cycles.

It is a feature of the invention to provide a method to dye high density polyethelene fiber fabric that easily allows the fabric to be stained any colors and patterns. This permits the military to use high density polyethelene fiber fabric (or more specifically Spectra®) as an outer fabric in field applications (e.g. camouflage cloth).

### DETAILED DESCRIPTION

The preferred embodiment of the present invention is illustrated by way of example below. The method for dyeing high density polyethelene fiber fabric or Spectra® fabric includes applying an aliphatic stain on the fabric. The fabric may be, but without limitation, dipped in aliphatic stain, or the aliphatic stain may be painted, rolled, coated, applied or sprayed on the fabric. The stain may be applied with the same technique as used with standard paints. Any method of application may be utilized so long as the aliphatic stain adheres to the fabric.

In the discussion of the present invention, the method will be discussed for high density polyethelene fiber fabric or Spectra® fabric in a military environment, specifically a military combat environment, however, the method can also be utilized for any items produced or manufactured with high density polyethelene fiber fabric, such as, but without limitation, clothes, cloth, boat sails, backpacks, furniture upholstery, outdoor furniture covers and luggage.

An aliphatic stain is a stain or coating that has an open or straight chain carbon compound. Aliphatic stains may have mineral spirits, gasoline, kerosene, hexane or naphta as an ingredient. Examples of aliphatic stains include commercial wood stain, and certain shoe polishes or tea. Both oil based and water based aliphatic wood stains have been found to be effective dyes for high density polyethelene fiber fabric that withstood repeated washes. During testing, oil based and water based aliphatic wood stains could not be removed from the fabric using cleaning agent methyl ethyl ketone.

In one of the embodiments of the invention, after an application of the aliphatic stain on the fabric, the stain is allowed to dry, and then subsequent coats of aliphatic stain are applied on the fabric. In the preferred embodiment, the drying time between coats is about 15 to about 20 minutes. For best results, after application of all coats of stain, the fabric should be allowed to dry for at least 24 hours prior to use.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment contained herein.

What is claimed is:

1. A method for dyeing high density polyethelene fiber fabric, the method comprising:
applying an aliphatic stain on the fabric.

2. The method for dyeing high density polyethelene fiber fabric of claim 1, wherein the aliphatic stain is a wood stain that is water based.

3. The method for dyeing high density polyethelene fiber fabric of claim 1, wherein the aliphatic stain is shoe polish.

4. The method for dyeing high density polyethelene fiber fabric of claim 1, wherein the aliphatic stain is tea.

5. The method for dyeing high density polyethelene fiber fabric of claim 1, wherein multiple coats are applied to the fabric and the stain is allowed to dry for up to about 20 minutes between coats.
